(19) United States
(12) Patent Application Publication
(10) Pub. No.: US 2016/0189224 A1
(43) Pub. Date: Jun. 30, 2016

(54) METHOD AND SYSTEM FOR ENABLING REFINING DELIVERY OF ADVERTISEMENTS

(71) Applicant: Sanjeev Madhava Rao, Manhattan Beach, CA (US)

(72) Inventor: Sanjeev Madhava Rao, Manhattan Beach, CA (US)

(21) Appl. No.: 14/587,203

(22) Filed: Dec. 31, 2014

(51) Int. Cl. G06Q 30/02

(52) U.S. Cl. CPC G06Q 30/0257; G06Q 30/0233; G06Q 30/0275

(57) ABSTRACT

The present disclosure provides a method and system for refining delivery of one or more advertisements in a content seen by one or more users. The method includes displaying the one or more advertisements in the content viewed by the one or more users, receiving a first input based on a first pre-defined criterion, collecting a second input based on a second pre-defined criterion and enabling a decision of refining the one or more advertisements. The first pre-defined criterion is based on a first interaction of a user of the one or more users with the one or more advertisements and a second interaction of the one or more users with the one or more advertisements. The second pre-defined criterion is based on skipping of a repetitive advertisement from the one or more advertisements.

### TECHNICAL FIELD

The present invention relates to the field of advertising and, in particular, relates to the refinement of advertisements to one or more users.

### BACKGROUND

Advertising is an ever evolving industry which functions on a fact of survival of the fittest. Nowadays more and more consumers are showing significant interest in viewing advertisements. The advertisements serve as a medium for the consumers to explore the various online and offline services. Many publishers have started displaying advertisements in a content. Advertisements are displayed to the consumers through various formats such as video, audio, text and the like. Further, the advertisements are displayed in both online and offline mode.

However, the advertisements shown in the content irritates a user. The user gets interrupted every time when the advertisements are encountered in viewing of the content. Further, nobody has time to watch the advertisements that do not suit his/her interests. For example, a male user while watching a video on a website (say www.youtube.com) encounters an advertisement regarding female products. The advertisement does not suit his interest and may annoy him. In such a case, it is a big concern for publishers in terms of their revenue generation strategy as it is least likely that the user will take action on the shown advertisement. Further, it does hurt the reputation of the publishers in the long run.

In the present scenario, some publishers provide a direct option to the user for skipping the advertisements by just simply clicking on the skip advertisement button. This is the easiest way of skipping the advertisements. Further, some systems provide the user an option of blocking the advertisements through various advertisement blocking softwares when the user is viewing the advertisements online. In addition, some current methods allow the users to skip the advertisements by paying an amount of money to the publisher.

The present systems and methods fail to provide a choice to the users for watching user selected advertisements and earning credits in return for viewing the advertisements. Moreover, the users do not have a provision to utilize the earned credits for attaining discounts on various goods or services or exchange the earned credits for money. Furthermore, the present system and methods do not provision the one or more publishers to envisage information related to the interests of the one or more users. The users do not have a provision for skipping advertisements which are not according to the interest of the users. The users are not provided with any benefit for watching the advertisement.

In the light of the above stated discussion, there is a need for a method and system that overcomes the above stated disadvantages.

### SUMMARY

In an aspect of the present disclosure, a computer-implemented method for refining delivery of one or more advertisements in a content seen by one or more users is provided. The computer-implemented method includes displaying, with a processor, the one or more advertisements in the content viewed by the one or more users; receiving, with the processor, the a first input based on a first pre-defined criterion; collecting, with the processor, a second input based on a second pre-defined criterion and enabling, with the processor, a decision of refining the delivery of the one or more advertisements. The one or more advertisements are provided by at least one of one or more publishers and a backend system and the one or more advertisements are provided to the one or more users based on a real time bidding process. The first pre-defined criterion is based on a first interaction of a user of the one or more users with the one or more advertisements and a second interaction of the one or more users with the one or more advertisements. The second pre-defined criterion is based on skipping of a repetitive advertisement from the one or more advertisements. The refining of the delivery of the one or more advertisements is based on the received first input and the collected second input.

In an embodiment of the present disclosure, the computer-implemented method further includes facilitating, with the processor, categorization of the one or more displayed advertisements. The categorization is based on a pre-determined criterion and the pre-determined criterion includes rating of the one or more displayed advertisements by the one or more users.

In an embodiment of the present disclosure, the computer-implemented method further includes facilitating, with the processor, earning of credits by watching the one or more displayed advertisements by the one or more users and the earning of credits is based on the categorization.

In an embodiment of the present disclosure, the computer-implemented method further includes allowing, with the processor, each of the one or more users to redeem the earned credits for skipping the one or more advertisements. The quantity of the credits redeemed by each of the one or more users is based on comparison of a first pre-determined amount decided on a real time basis utilizing a bidding criterion with a second pre-determined amount decided by the corresponding one or more users for skipping the one or more advertisements. The bidding criterion is based on the real-time bidding of one or more advertisement slots of the one or more publishers.

In an embodiment of the present disclosure, the credits are deducted from an account of each of the one or more users based on a bidding amount for skipping the one or more advertisements and the bidding amount is based on compensation methods. In another embodiment of the present disclosure, the compensation methods include at least one of cost per click, cost per impression and cost per view.

In an embodiment of the present disclosure, the computer-implemented method further includes storing, with the processor, information of the one or more users, the earned credits by each of the one or more users, one or more attributes of the one or more displayed advertisements based on the first pre-defined criterion and one or more attributes of the one or more displayed advertisements based on the second pre-defined criterion.

In yet another aspect of the present disclosure, a system for refining delivery of one or more advertisements in a content seen by one or more users is provided. The system includes a presentation module in a processor, the presentation module configured to display the one or more advertisements in the content viewed by the one or more users, a receiving module in the processor, the receiving module configured to receive a first input based on a first pre-defined criterion, an assembling engine in the processor, the assembling engine configured to collect a second input based on a second pre-defined criterion and a decision module in the processor, the decision module configured to enable a decision of refining the delivery of the one or more advertisements. The one or more advertisements are provided by at least one of one or more publishers and a backend system. The one or more advertisements are provided to the one or more users based on a real time bidding process. The first pre-defined criterion is based on a first interaction of a user of the one or more users with the one or more advertisements and a second interaction of the one or more users with the one or more advertisements. The second pre-defined criterion is based on skipping of a repetitive advertisement from the one or more advertisements. The refining of the delivery of the one or more advertisements is based on the received first input and the collected second input.

In an embodiment of the present disclosure, the system further includes a categorization module in the processor, the categorization module configured to facilitate categorization of the one or more displayed advertisements. The categorization is based on a pre-determined criterion and the pre-determined criterion includes rating the one or more displayed advertisements by the one or more users.

In an embodiment of the present disclosure, the system further includes a facilitation module in the processor, the facilitation module configured to facilitate earning of credits by watching the one or more displayed advertisements by the one or more users and the earning of credits is based on the categorization.

In an embodiment of the present disclosure, the system further includes a compensator module in the processor, the compensator module configured to allow each of the one or more users to redeem the earned credits for skipping the one or more advertisements. The quantity of the credits redeemed by each of the one or more users is based on a comparison of a first pre-determined amount decided on the real time basis utilizing a bidding criterion with a second pre-determined amount decided by the corresponding one or more users for skipping the one or more advertisements. The bidding criterion is based on the real-time bidding of one or more advertisement slots of the one or more publishers.

In an embodiment of the present disclosure, the system further includes a mapping module in the processor, the mapping module configured to map one or more attributes of each of the one or more displayed advertisements with one or more attributes of the one or more advertisements based on the first pre-defined criterion and one or more attributes of the one or more advertisements based on the second pre-defined criterion.

In an embodiment of the present disclosure, the one or more attributes of each of the one or more advertisements includes at least one of type of the one or more advertisements and rating of the one or more displayed advertisements by the user of the one or more users and the one or more users.

In an embodiment of the present disclosure, the credits are deducted from an account of the one or more users based on a bidding amount for skipping the one or more advertisements and the bidding amount is based on compensation methods. In another embodiment of the present disclosure, the compensation methods include at least one of cost per click, cost per impression and cost per view.

In an embodiment of the present disclosure, the system further includes a database in the processor, for storing information of the one or more users, the earned credits by each of the one or more users, the one or more attributes of each of the one or more advertisements based on the first pre-defined criterion and the one or more attributes of each of the one or more advertisements based on the second pre-defined criterion.

In another aspect of the present disclosure, a computer system is provided. The computer system includes a non-transitory computer readable medium storing a computer readable program; the computer readable program when executed on a computer causes the computer to perform steps. The steps include displaying one or more advertisements in a content viewed by one or more users, receiving a first input based on a first pre-defined criterion, collecting a second input based on a second pre-defined criterion and enabling a decision of refining delivery of the one or more advertisements. The one or more advertisements are provided by at least one of one or more publishers and a backend system. The one or more advertisements are provided to the one or more users based on a real time bidding process. The first pre-defined criterion is based on a first interaction of a user of the one or more users with the one or more advertisements and a second interaction of the one or more users with the one or more advertisements. The second pre-defined criterion is based on skipping of a repetitive advertisement from the one or more advertisements. The refining of the delivery of the one or more advertisements is based on the received first input and the collected second input.

In an embodiment of the present disclosure, the computer readable program when executed on the computer causes the computer to perform a further step of facilitating categorization of the one or more displayed advertisements. The categorization is based on a pre-determined criterion and the pre-determined criterion includes rating of the one or more displayed advertisements by the one or more users.

In an embodiment of the present disclosure, the computer readable program when executed on the computer causes the computer to perform a further step of facilitating earning of credits by watching the one or more displayed advertisements by the one or more users and the earning of credits is based on the categorization.

In an embodiment of the present disclosure, the computer readable program when executed on the computer causes the computer to perform a further step of allowing the one or more users to redeem the earned credits for skipping the one or more advertisements.

### BRIEF DESCRIPTION OF THE FIGURES

Having thus described the invention in general terms, reference will now be made to the accompanying drawings, which are not necessarily drawn to scale, and wherein:

FIG. 1 illustrates a general overview of the system for enabling refining of delivery of one or more advertisements, in accordance with various embodiments of the present disclosure;

FIG. 2 illustrates a system for enabling refining of the delivery of the one or more advertisements, in accordance with various embodiments of the present disclosure;

FIG. 3 illustrates a block diagram of a communication device, in accordance with various embodiments of the present disclosure;

FIG. 4 illustrates a flowchart for enabling refining the delivery of the one or more advertisements, in accordance with various embodiments of the present disclosure; and

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

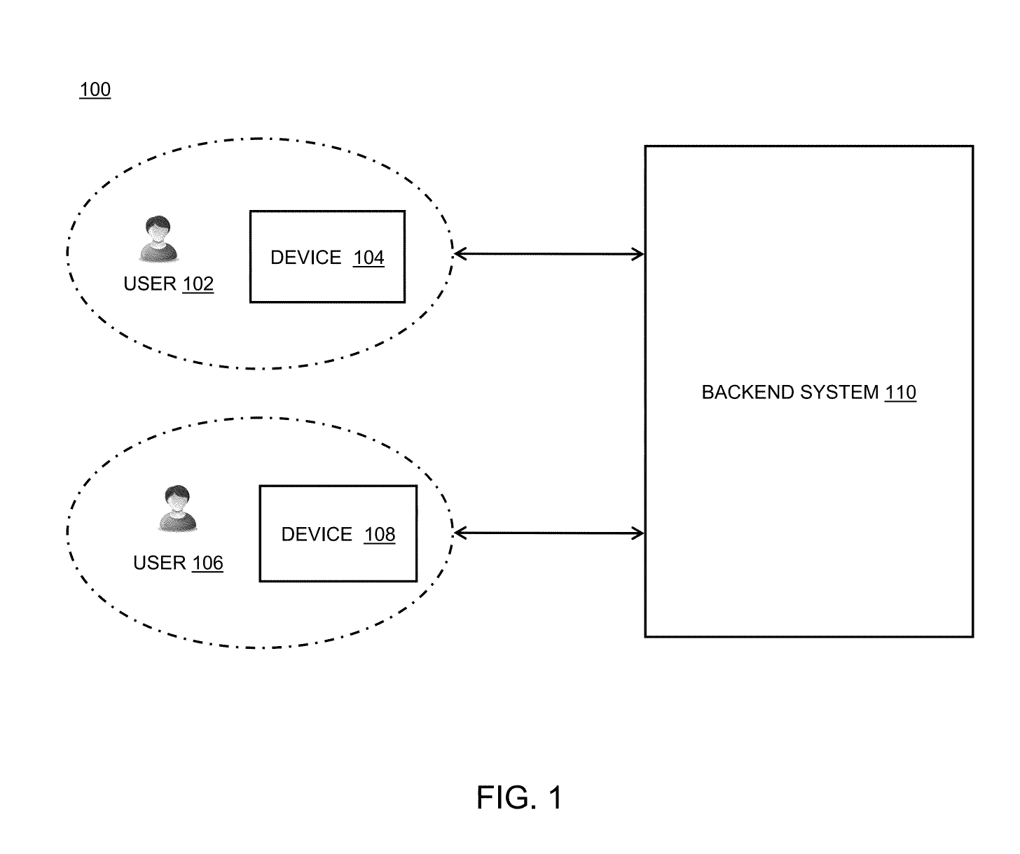

FIG. 1 illustrates a general overview of the system 100 for enabling refining of delivery of one or more advertisements, in accordance with various embodiments of the present disclosure. The system 100 includes a device 104 associated with a user 102, a device 108 associated with a user 106 and a backend system 110. The user 102-106 may be any individual or a person accessing the device 104-108. Examples of the device 104-108 may include but not be limited to laptops, mobile phones, computers, tablets, a television set and a personal digital assistant (PDA). The device 104-108 may be connected to an internet system, a local area connection, a wide area network, and the like.

The back-end system 110 provides the one or more advertisements to the user 102-106 in the content seen by the user 102-106 on the device 104-108. The one or more advertisements include audio advertisements, video advertisements, textual advertisements, flash advertisements, rich media advertisements (For example, HTML advertisement) and the like. Further, an advertisement from the one or more advertisements may be in the form of a short survey poll for promotion. In addition, the backend system 110 provides the one or more advertisements to the user 102-106 based on a real time bidding process. The user 102 of the one or more users 102-106 views the content on the device 104 of the one or more devices 104-108. The content may be an online content or offline content, live or delayed, video on demand, packaged as streaming and the like. Further, the content may take a form of mobile applications and games providing display of the one or more advertisements. Moreover, content may include but not be limited to an audio content, a video content, a flash content, text content and HTML content. Further, the user 102 views the online content and the offline content on the device 104 according to his/her specific interests. The user 102 may be interested in watching videos related to sports, movies or any recreational activity, listening songs, visiting social networking sites or any other content according to the choice of the user 102. For example, a user X watches an advertisement of a mobile brand and a popular shoe brand while watching an episode of a popular TV series on his/her laptop. Also, a user Y watches an advertisement related to sports utilities and real estate while watching a popular comedy show on his/her television.

In an example embodiment of the present disclosure, a user A playing a soldier combat game B on a mobile phone C watches an advertisement D or takes a survey related to his or her experience regarding the soldier combat game B for gaining access to a next level or for unlocking a new body armor in the soldier combat game B. Further, the user B accepts offers for gaining the access to the next level or unlocking the new body armor.

Further, one or more publishers provide the one or more advertisements to the backend system 110. Examples of the one or more publishers may include but not be limited to youtube, dailymotion, facebook, news channels, movie channels and the like. In an embodiment of the present disclosure, the backend system 110 provides the one or more advertisements directly to the user 102. In another embodiment of the present disclosure, the backend system 110 is a part of the one or more publishers which provides the one or more advertisements. In yet another embodiment of the present disclosure, the backend system 110 maintains a website for providing the one or more advertisements. Continuing with the above stated example, the user X watches the episode of the TV series on youtube and the advertisements watched by the user X was provided by the youtube. However, the user Y watches the popular comedy show on his/her television and the advertisements were provided directly by the backend system 110.

Going, further, the backend system 110 facilitates categorization of the one or more viewed advertisements based on a pre-determined criterion. The pre-determined criterion provisions the user 102-106 to rate each advertisement of the one or more viewed advertisements. The user 102-106 rate the one or more viewed advertisements based on at least one of visual appeal of the one or more viewed advertisements, social cause depicted in the one or more viewed advertisements, interest of the user 102-106 in the one or more viewed advertisements and content of the one or more viewed advertisements. Extending the above stated example, the user X rates the mobile brand advertisement and the shoe brand advertisement. The mobile brand advertisement becomes a moderately rated advertisement and the shoe brand advertisement becomes a highly rated advertisement based on the ratings given by the user X and other one or more users (say Z1 and Z2). Also, the user Y rates the sports utilities advertisement and the real estate advertisement. The sports utilities advertisement becomes a moderately rated advertisement and the real estate advertisement becomes a highly rated advertisement based on the ratings given by the user Y and other one or more users (say Z1, Z2, Z3 and Z4).

Further, the backend system 110 rewards the user 102-106 with a credit currency for viewing, categorizing and rating the one or more viewed advertisements. The credit currency may include but not be limited to virtual currency (for example, credit points, bit coins and the like) and paper currency. The credit currency is stored in an account associated with the user 102-106 (registered user). In addition, the back-end system 110 allows the user 102-106 to redeem the credit currency for skipping the one or more other advertisements. In an embodiment of the present disclosure, the backend system 110 allows the user to redeem the credit currency for one or more services. In another embodiment of the present disclosure, the backend system 110 rewards the user 102-106 for answering questions to a survey related to the one or more viewed advertisements. In yet another embodiment of the present disclosure, the backend system 110 rewards the user 102-106 clicking on the one or more viewed advertisements. Continuing with the above stated example, the user X earns 0.12$ for rating each of the mobile brand advertisement and the shoe brand advertisement. Also, the user Y earns 0.13$ for clicking on the sports utilities advertisements and the real estate advertisements. The backend system 110 decides the credit amount for watching the advertisement by the user X.

Going further, the backend system 110 receives a first input based on a first pre-defined criterion. The first pre-defined criterion includes the categorization of the one or more viewed advertisements by the user 102-106 and other one or more users.

The backend system 110 collects a second input based on a second pre-defined criterion. The second pre-defined criterion is based on skipping of a repetitive advertisement from the one or more advertisements. Further, the second pre-defined criterion includes providing an option to the user 102-106 with a provision of choosing one or more type of advertisements according to preference of the user 102-106. For example, a user A chooses to view advertisements related to mobile phones, apparels and cars and a user B chooses to view advertisements related to sports and shoe brand. Also, the user A decides not to view the mobile phone advertisements which the user A has already seen and the user B defines a number of times for the same shoe brand advertisement to be displayed.

Furthermore, the backend system 110 provides the one or more categorized advertisements to the user 102-106. Continuing with the above stated example, the user A watches an advertisement of a new mobile phone handset and a health care product while watching highlights of football world cup final on youtube on his/her laptop and the user B watches an advertisement of a sportswear brand and a car brand while watching a movie on his/her television set.

In addition, the backend system 110 maps one or more attributes of the one or more displayed advertisements with one or more attributes of each of the one or more advertisements based on the first pre-defined criterion and one or more attributes of each of the one or more advertisements based on the second pre-defined criterion. The one or more attributes of the one or more advertisements provided to the user 102-106 may include but not be limited to content of the one or more advertisements, rating of the one or more advertisements by the user 102-106 and the other one or more users, creation date of the one or more advertisements, first air date of the one or more advertisements and the like.

Moreover, the backend system 110 enables a decision to limit the delivery of the advertisement from the one or more advertisements provided to the user 102-106 based on the mapping of the one or more attributes of the one or more categorized advertisements. Extending the above stated example, the user A watches the new mobile phone handset advertisement and skips the health care product advertisement while watching the highlights of the football world cup final. Also, the user B watches the advertisement of the sportswear brand and skips the advertisement of the car brand.

It may be noted that in FIG. 1, the user 102 and the user 106 earns the credit currency by viewing, categorizing and then rating the one or more advertisements; however those skilled in the art would appreciate that more number of users can earn the credit currency by viewing, categorizing and then rating the one or more advertisements. It may also be noted that in FIG. 1, the user 102 is associated with the device 104 and the user 106 is associated with the device 108; however those skilled in the art would appreciate that more users can be associated with more devices for watching the content. For example, a user X, a user Y and a user Z are associated with a communication device D1, a communication device D2 and a communication device D3.

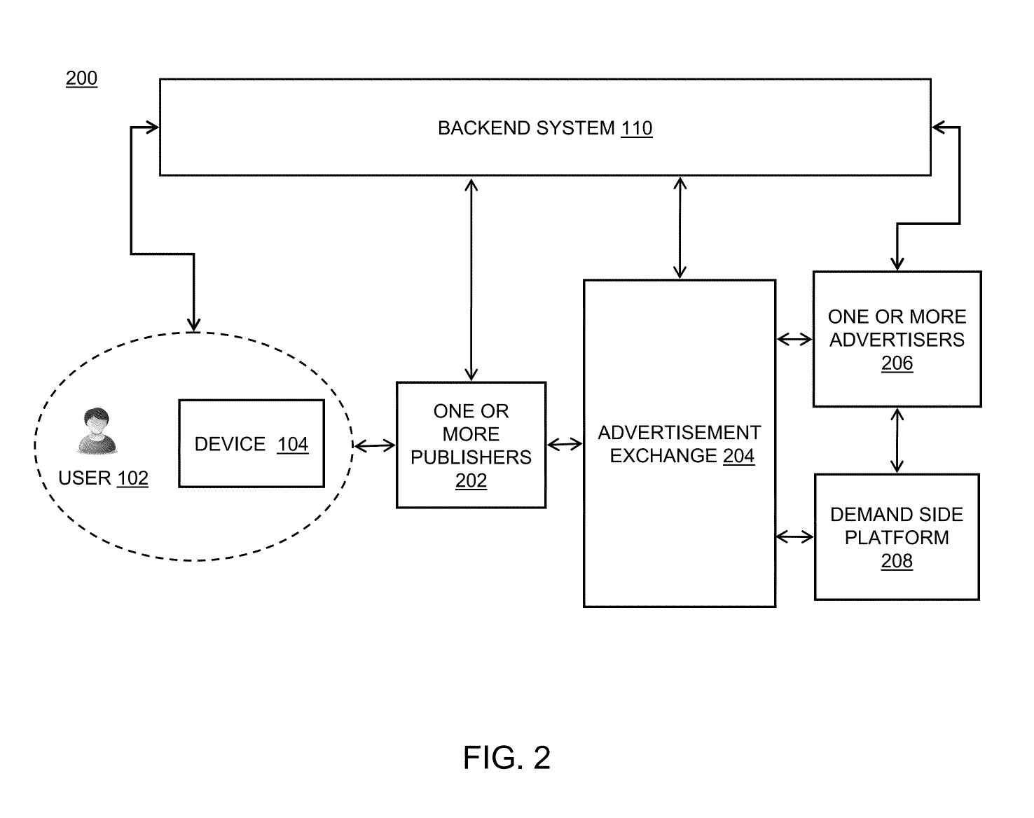

FIG. 2 illustrates a system 200 for enabling refining of the delivery of one or more advertisements in a content seen by the one or more users, in accordance with various embodiments of the present disclosure. It may be noted that to explain the system elements of FIG. 2, references will be made to the system elements of the FIG. 1. The system 200 depicts an interconnection of the backend system 110 with the user 102 associated with the device 104, one or more publishers 202, an advertisement exchange 204, one or more advertisers 206 and a demand side platform 208. Each of the one or more publishers 202 provide or display online and offline content, live or delayed content, video on demand and the like to the user 102. The content may include one or more publisher content, one or more video content, one or more audio content, one or more text content and the like.

The one or more publishers 202 advertise products, services or businesses to the users 102 for generating revenue. In an embodiment of the present disclosure, the backend system 110 provides the content to the user 102 directly through a website owned by the backend system 110. In another embodiment of the present disclosure, the backend system 110 is a part of the one or more publishers 202 for providing the content to the user 102. In another embodiment, the one or more publishers 202 are associated with the one or more advertisers 206 through the advertisement exchange 204. The one or more advertisers 206 provide advertisements to the one or more publishers 202. In another embodiment, the one or more publishers 110 are associated with the one or more advertisers 206 through the advertisement exchange 204.

The one or more advertisers 206 may be one or more brands, one or more manufacturers, one or more retailers, one or more service providers, one or more government agencies and the like. Further, the one or more advertisers 206 provide the one or more advertisement to convey information to the one or more users, to generate a response from the one or more users, to prompt the one or more users in making a purchase or to ask the one or more users to participate in any online or offline event.

The advertisement exchange 204 provides a platform for the one or more publishers 202 and the one or more advertisers 206 for buying and selling of advertisement inventory. In an embodiment of the present disclosure, the backend system 110 facilitates the buying and selling of the advertisement inventory between the one or more publishers 202 and the one or more advertisers 206. Examples of the advertisement exchange 204 include but may not be limited to Microsoft AdECN, Yahoo Right Media, DoubleClick, AppNexus, OpenX. In an embodiment of the present disclosure, the one or more publishers 202 and the one or more advertisers 206 deal directly without the intervention of the advertisement exchange 204. In another embodiment of the present disclosure, the backend system 110 facilitates the direct dealing between the one or more publishers 202 and the one or more advertisers 206.

Going further, the one or more advertisers 206 are associated with the demand side platform 208. The demand side platform 208 allows the one or more advertisers 206 to buy one or more advertisement slots. Further, the demand side platform 208 is a tool that automates the purchasing of the one or more advertisement slots on behalf of the one or more advertisers 206. Examples of the demand side platform 208 include but may not be limited to Google's Invite Media, MediaMath, Turn, DataXu and X+1. In an embodiment of the present disclosure, the backend system 110 facilitates the purchasing of the one or more advertisement slots for the one or more advertisers 206.

The backend system 110 provides the one or more advertisements in the content viewed by the user 102. Further, the backend system 110 provides the one or more advertisements based on the real time bidding process. In an embodiment of the present disclosure, the one or more publishers 202 provide the one or more advertisements to the user 102. The advertisement exchange 204 facilitates the real time bidding of the one or more advertisement slots between the one or more publishers 202 and the one or more advertisers 206.

In an embodiment of the present disclosure, the backend system 110 provides the one or more advertisements in form of a poll or survey to the user 102. The backend system 110 collects information associated with the user 102 and stores a profile of the user 102.

In another embodiment of the present disclosure, the backend system 110 provides queries which haven't been answered earlier or doesn't have a recent answer.

In yet another embodiment of the present disclosure, the one or more advertisers 206 receive good quality of data through the survey.

In yet another embodiment of the present disclosure, the backend system 110 provides the one or more advertisements in the form of the survey through the real time bidding process. However, the real time bidding of the one or more advertisements in the form of the survey is not as robust.

In yet another embodiment of the present disclosure, the backend system 110 provisions the user 102 to delete his or her profile at anytime and become virtually invisible.

The real time bidding allows the one or more advertisers 206 and the one or more publishers 202 to take part in a real time auction facilitated by the advertisement exchange 204. In an embodiment of the present disclosure, the backend system 110 is a part of the advertisement exchange 204 for facilitating the real time bidding of the one or more advertisement slots. The one or more publishers 202 provide the advertisement slots to the advertisement exchange 204. The demand side platform 208 decides the advertisement slots the one or more advertisers 204 should buy. The price of the advertisement slots is decided through the real time auction. The real time auction takes place in milliseconds before the content loads. The one or more publishers 202 provide their advertisement inventory to the advertisement exchange 204 which hold the real time auction. The demand side platform 208 bids on behalf of the one or more advertisers 206 for winning the advertisement slots. Value of a bid placed by the demand side platform 208 for the one or more advertisers 206 is determined by buying parameters set by the one or more advertisers 206. The real time bidding process terminates many advertisers from the one or more advertisers 206 as an advertiser with a highest bid is declared the winner of a particular advertisement slot from the one or more advertisement slots and allowed to show his or her advertisement in the particular advertisement slot.

For example, a user Y loads a music video C on a publisher B and at the same time, an advertiser A1 places a bid of 0.14$, an advertiser A2 places a bid of 0.11$ and an advertiser A3 places a bid of 0.15$ for placing their advertisement X, Y and Z on an advertisement slot t1 of the publisher B. The advertisement exchange 204 decides the winner of the advertisement slot t1 of the publisher B and declares the advertiser A3 with the bid of 0.15$ as the winner and allows the advertiser A3 to place the advertisement Z on the advertisement slot t1 for the user Y to view.

In an embodiment of the present disclosure, the backend system 110 enables skipping of those advertisements for which the amount set by the user 102 exceeds or equals to a fees calculated by the backend system 110. In an embodiment of the present disclosure, the fees calculated by the backend system 110 for each advertisement slot in the content is determined at least in part by calculating an probabilistic amount which the one or more publishers 202 would have got from the advertisers 206 and/or advertisement exchange in the real time bidding or past data of real time bidding had the user 102 not even opted to exploring the option to skip the advertisement.

Continuing with the above stated example, the user Y sets an amount of 0.18$ for skipping the advertisement Z with the bidding amount of 0.15$ in the advertisement slot t1. The backend system 110 allows the user Y to skip the advertisement Z since the amount set by the user Y (0.18$) exceeds the real time bidding amount of the advertisement Z (0.15$) placed by the advertiser A3.

In an embodiment of the present disclosure, the backend system 110 may give an option to the user Y to skip all the advertisement slots (say t1, t2, t3 and t4) in the music video C of the publisher B. The user Y is given an option to bid for skipping each of the four advertisement slots (t1, t2, t3 and t4). The user Y bids a total amount of 0.85$ for skipping all the advertisement slots t1, t2, t3 and t4. In an embodiment of the present disclosure, the user Y bids 0.14$ for the slot t1, 0.13$ for the slot t2, 0.23$ for the slot t3 and 0.31$ for the slot t4 for skipping each of the advertisement slots. The real time bidding amount is calculated through the pre-determined criterion. The highest bid amount of the advertisement slot t1 is 0.15$, for slot t2 is 0.10$, for slot t3 is 0.19$ and for slot t4 is 0.25$. The backend system 110 compares the real time bidding amount of each of the slots (t1, t2, t3 and t4) of the music video C of the publisher B with the corresponding bid amount set by the user Y for skipping each of the slots (t1, t2, t3 and t4). The backend system 110 skips the advertisement slots t2, t3 and t4 in the music video C of the publisher B. In an embodiment of the present disclosure, the backend system 110 calculates the total sum for the real time bidding amounts of the advertisement slots t1, t2, t3 and t4 (0.15$+0.10$+0.19$+0.25$=0.69$, according to our example) and compares it with the total bidding amount set by the user B (0.85$) for skipping all the advertisement slots. The backend system 110 skips all the advertisement slots t1, t2, t3 and t4 in the music video C of the publisher B since the bidding amount set by the user Y exceeds the total real time bidding amount of the advertisement slots t1, t2, t3 and t4.

Going further, the backend system 110 facilitates the categorization of the one or more viewed advertisements. Further, the backend system 110 categorizes the one or more advertisements by allowing the user 102 and other one or more users to rate the one or more viewed advertisements. In an embodiment of the present disclosure, the user 102 associates zero or one or more categories to the one or more viewed advertisements.

Moreover, the user 102 and the other one or more users rate the one or more advertisements based on the visual appeal of the one or more advertisements, the social cause depicted in the one or more advertisements and the like. In an embodiment of the present disclosure, the user 102 associates zero or one or more ratings to the one or more viewed advertisements. In another embodiment of the present disclosure, the user 102 provides a numeric value in a pre-determined range for rating the one or more viewed advertisements In yet another embodiment of the present disclosure, the user 102 and the other one or more users categorize the one or more viewed advertisements by volunteering in a survey conducted by the backend system 110.

In an embodiment of the present disclosure, the backend system 110 learns and optimizes the one or more advertisements which are most watched, tolerable and relevant to the one or more users and which pay out the most.

For example, a user K views an advertisement of a shoe brand while watching news on youtube on his/her desktop and rates the advertisement on basis of interaction of the user K with the advertisement. The user K gives four out of five stars to the viewed advertisement. Also, a user L views an advertisement of a watch brand while watching a movie on his/her television set. The user L takes part in a survey associated with the advertisement of the watch brand. The backend system 110 categorizes the watch brand advertisement based on the survey conducted.

Further, the backend system 110 allows the user 102 and the other one or more users to earn credits for viewing, categorizing and rating the one or more advertisements. The credits earned by the user 102 and the other one or more users may include but not be limited to the virtual currency (for example, credit points, bit coins and the like) and the paper currency. The quantity of the earned credits by the user 102 and the other one or more users is based on a comparison of a first pre-determined amount decided on the real time basis utilizing a bidding criterion with a second pre-determined amount decided by corresponding user 102 and other one or more users for skipping the one or more advertisements. The bidding criterion is based on the real time bidding of the one or more advertisement slots of the one or more publishers 202. Further, the user 102 utilizes the earned credits for at least one of availing offers, receiving real money in exchange of the earned credits and discounts. Moreover, the backend system 110 deducts an amount from an account of the user 102 (registered user) for skipping the one or more advertisements. The account of the user 102 stores the credits earned by the user 102. Further, the credits are utilized for paying an amount for each skipped advertisement. The deducted amount is decided based on the real time bidding process. In an embodiment of the present disclosure, the deducted amount in form of the earned credits is same as real time bid value for the corresponding skipped advertisement.

In yet another embodiment of the present disclosure, a marketer or a retailer may incentivize the user 102 to buy a product/service from his/her store by bundling a no-cost advertisement-free experience at any place for a period of time. For example, a user may be incentivized by a car brand (for example, Ford) to buy their cars and get a year's worth of ad-free experience on any publisher at any place wherever he/she goes. In an embodiment of the present disclosure, the car brand may pay the cost of all the advertisements watched by the user 102 for one year, no matter how many advertisements the user 102 skips.

Continuing with the above stated example, the user K earns a credit (say 0.1$) for viewing and rating the shoe brand advertisement and the user L earns a credit (say 0.2$) for viewing and rating the watch brand advertisement. The user K utilizes the earned credit (0.1$) for skipping an advertisement of a health care product and the user L utilizes the earned credit (0.2$) for skipping an advertisement of a bathing soap.

In an embodiment of the present disclosure, the credits are deducted from the account of each of the one or more users based on the bidding amount for skipping the one or more advertisements and the bidding amount is based on compensation methods.

In another embodiment of the present disclosure, the compensation methods include at least one of cost per click, cost per impression and cost per view.

Furthermore, the backend system 110 receives the first input based on the first pre-defined criterion. The first pre-defined criterion includes the categorization of the one or more viewed advertisements by the user 102 and other one or more users. In an embodiment of the present disclosure, the backend system 110 stores information related to the one or more rated advertisements by the user 102 and the other one or more users.

The backend system 100 collects the second input based on the second pre-defined criteria. The second pre-defined criterion is based on the skipping of the repetitive advertisement from the one or more advertisements. Further, the second pre-defined criterion includes providing an option to the user 102 with the provision of choosing one or more type of advertisements according to preference of the user 102. In an embodiment of the present disclosure, the backend system 110 provides the user 102 with a pre-defined list of the one or more type of advertisements for the user 102 to choose. In another embodiment of the present disclosure, the backend system 110 provides the list of the one or more type of advertisements based on the rating of the one or more viewed advertisements by the user 102 and the other one or more users. In yet another embodiment of the present disclosure, the backend system 110 allows the user 102 to decide what advertisements they want to skip. In yet another embodiment of the present disclosure, the backend system 110 enables skipping of an advertisement from the one or more advertisements on the basis of the preference of the user 102. In yet another embodiment of the present disclosure, the backend system 110 allows the user 102 to define an access of level of data granularity. In yet another embodiment of the present disclosure, the backend system 110 allows the user 102 to decide whose access is revoked.

For example, a user M chooses to view advertisements related to shoes, gym equipments and cricket and a user N chooses to view advertisements related to software, and laptops. Also, the user M decides not to view the sports advertisements which the user M has already seen and the user N defines a number of times for the same laptop advertisement to be displayed.

Moreover, the backend system 110 displays the one or more categorized advertisements to the user 102 in the content. Further, the backend system 110 provides the one or more categorized advertisements through the website owned by the backend system 110. The one or more categorized advertisements are the previously rated advertisements by the user 102 and the other one or more users. In an embodiment of the present disclosure, the one or more publishers 202 provide the one or more advertisements to the user 102. In an embodiment of the present disclosure, the one or more advertisements are highly rated advertisements provided to the user 102 based on the categorization of the one or more advertisements.

In an embodiment of the present disclosure, the one or more categorized advertisements are provided based on the real time bidding process hosted by the advertisement exchange 204 between the one or more publishers 202 and the one or more advertisers 206.

Continuing with the above stated example, an advertiser P, an advertiser Q and an advertiser R bid for placing their advertisements on the advertisement slot S1 and S2 in the news video T of the publisher U watched by the user M. The advertiser P wants to place an advertisement of a shoe brand in the slot S1 and an apparel brand in the slot S2 which has been rated highly by one or more users X, the advertiser Q wants to place an advertisement of a mobile brand in the slot S1 and a cricket bat in the slot S2 which has been rated highly by the one or more users X and the advertiser R wants to place an advertisement of a laptop brand in the slot S1 and a LED in the slot S2 which has been rated moderately by one or more users X. The advertiser P places a bid of 0.24$ for placing the shoe brand advertisement in the slot S1 and 0.30$ for placing the apparel brand advertisement in the slot S2, the advertiser Q places a bid of 0.23$ for placing the mobile brand advertisement in the slot S1 and 0.31$ for placing the watch brand advertisement in the slot S2 and the advertiser R places a bid of 0.22$ for placing the laptop brand advertisement in the slot S1 and 0.25$ for placing the LED advertisement in the slot S2. The backend system 110 decides to provide the advertisement of the advertiser P (shoe brand advertisement) in the slot S1 and the advertisement of the advertiser Q (watch brand advertisement) in the advertisement slot S2.

Further, the backend system 110 maps the one or more attributes of the displayed one or more advertisements with the one or more attributes of each of the one or more advertisements based on the first pre-defined criterion and the one or more attributes of each of the one or more advertisements based on the second pre-defined criterion. The one or more attributes of the one or more advertisements provided to the user 102 may include but not be limited to the content of the one or more advertisements, the rating of the one or more advertisements by the user 102 and the other one or more users, the creation date of the one or more advertisements, the first air date of the one or more advertisements and the like. In an embodiment of the present disclosure, the backend system 110 checks the preference of the user 102 against the one or more displayed advertisements. In another embodiment of the present disclosure, the backend system 110 checks whether the one or more advertisements provided to the user 102 were advertised previously or not. Extending with the above stated example, the user M is provided with the advertisement of a cricket bat which has been given a rating of four out of five stars and the advertisement of the apparel brand which has been given four out of five stars and the user N is provided with the advertisement of the laptop which has been given five out of five stars and the advertisement of the mobile phone which has been given four out of five stars.

The backend system 110 enables the refining of the delivery of the one or more categorized advertisements based on the mapping of the one or more attributes associated with the one or more categorized advertisements. In an embodiment of the present disclosure, the backend system 110 enables skipping of the advertisement from the one or more advertisements. Further, the backend system 110 enables the skipping of the advertisement from the one or more advertisements based on the first pre-defined criterion and the second pre-defined criterion. In another embodiment of the present disclosure, the backend system 110 prompts the user 102-106 to watch the advertisement from the one or more advertisements based on the mapping of the one or more attributes of the categorized advertisement. In yet another embodiment of the present disclosure, the backend system 110 automatically skips/streams the one or more categorized advertisements in real time. As mentioned in the above stated example, the user M watches the advertisement of the cricket bat and skips the advertisement of the apparel brand. Also, the user N watches the advertisement of the laptop and skips the advertisement of the mobile phone.

In an embodiment of the present disclosure, the backend system 110 automatically skips the advertisements which are not listed in the preference list of the user 102 and given a high rating by the other one or more users. On the contrary, the backend system 110 streams the advertisements listed in the preference list of the user 102 and given a high rating by the other one or more users despite the fact that the user 102 has an option of skipping the advertisement. In another embodiment of the present disclosure, the backend system 110 forces the user 102 to view the advertisement of the one or more advertisements.

Continuing with the above stated example, the user M receives the shoe brand advertisement in the advertisement slot S1 and the watch brand advertisement in the advertisement slot S2. Since the user M has previously chosen to view only advertisements related to the shoes, the gym equipments and the cricket, the backend system 110 plays the shoe brand advertisement in the slot S1 even if the user M has chosen to skip the advertisement and skips the watch brand advertisement in the slot S2. Further, the user M pays the one or more publishers 202 for skipping the watch brand advertisement in the slot S2 by the credits earned while viewing and rating the one or more advertisements.

In an embodiment of the present disclosure, the user 102 can earn more credits for watching the advertisement of his choice.

In another embodiment of the present disclosure, the back end system 110 allows the user 102 to redeem the earned credits for skipping the one or more advertisements.

In yet another embodiment of the present disclosure, the backend system 110 allows the user 102 to redeem credits after completion of the poll or survey.

In yet another embodiment of the present disclosure, the user 102 redeems the earned credits for getting paid via cash or a gift card or songs or any form of cash/non-cash compensation.

In yet another embodiment of the present disclosure, the user 102 earns the credits during the viewing of the advertisement after an each pre-defined interval. For example, a user Z is viewing an advertisement having a playtime of two minutes. The user Z earns credits after each 20 second intervals (say at 20 sec, 40 sec, and 60 sec). The user Z earns a fraction of the total credits to be earned after the finishing of the advertisement.

In yet another embodiment of the present disclosure, the user 102 earns the credits after watching the entire advertisement.

In yet another embodiment of the present disclosure, the method provides mobile applications with a SDK that supports both ad-supported free or one time paid platforms, thereby allowing the user 102-106 to watch/skip the advertisements with little amount of money.

In yet another embodiment of the present disclosure, the backend system 110 stores the information of the one or more users, credits earned by each of the one or more users, number of skipped and watched advertisements by each of the one or more users and the like.

In yet another embodiment of the present disclosure, the backend system 110 allows the user 102 an option to bid for skipping each of the advertisements in the advertisement slots of the content.

In yet another embodiment of the present disclosure, the user 102 configures his/her choices through the account on the backend system 110 associated with a television or a set top box via a physical remote.

In yet another embodiment of the present disclosure, the user 102 is provided with a button on the physical remote or in software settings of the set top box for directly skipping the advertisements while watching the content on his/her television set.

In yet another embodiment of the present disclosure, one or more devices (mobile and desktop) are equipped with rich media ad formats such as VPAID, MRAID and the like for overlaying an advertisement on top of an underlying advertisement. Further, the one or more users are given a choice to pay for skipping the advertisements or to view the underlying advertisement.

It may be noted that in FIG. 2, the user 102 earns the credit currency by viewing, categorizing and then rating the one or more advertisements; however those skilled in the art would appreciate that more number of users can earn the credit currency by viewing, categorizing and then rating the one or more advertisements. It may also be noted that in FIG. 2, the user 102 is associated with the device 104; however those skilled in the art would appreciate that more users can be associated with more devices for watching the content. For example, a user X, a user Y and a user Z are associated with a communication device Dl, a communication device D2 and a communication device D3.

It may also be noted that in FIG. 2, the advertisement exchange 204 facilitates the real time bidding between the one or more publishers 202 and the one or more advertisers 206; however those skilled in the art would appreciate that there are more advertisement exchanges facilitating the real time bidding process.

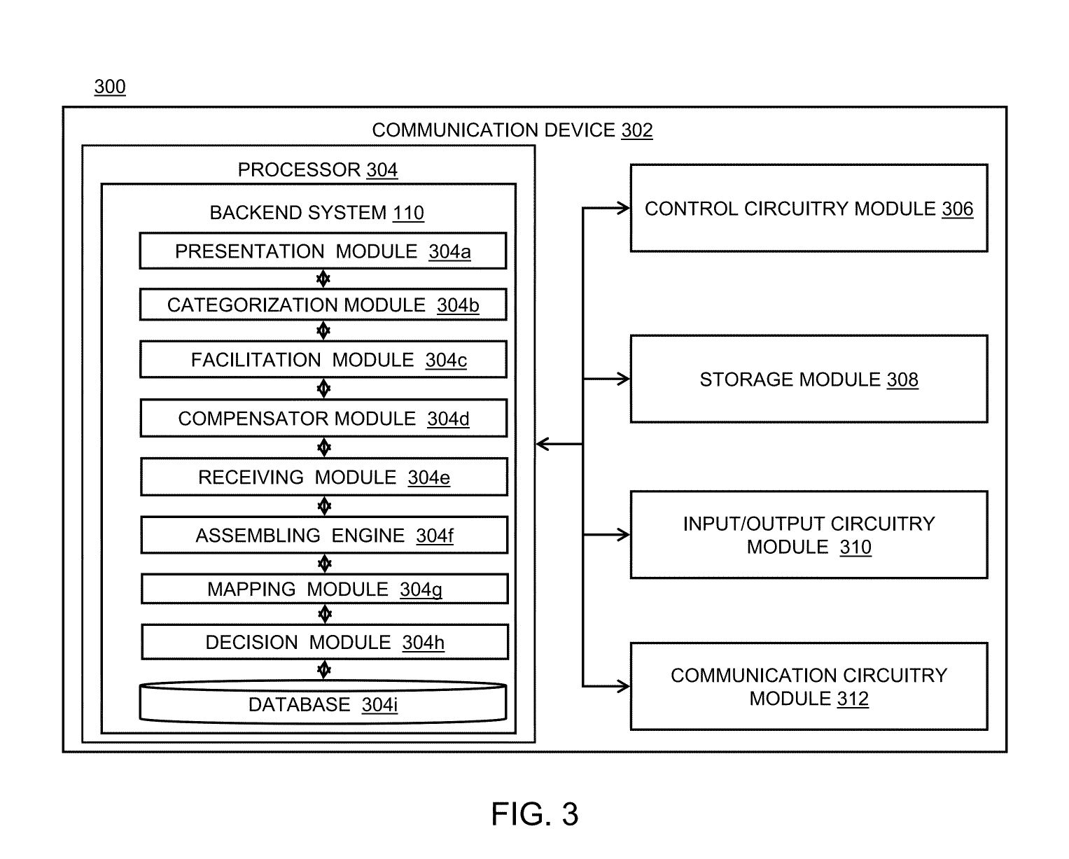

FIG. 3 illustrates a block diagram 300 of a communication device 302, in accordance with various embodiments of the present disclosure. The communication device 302 includes a processor 304, a control circuitry module 306, a storage module 308, an input/output circuitry module 310 and a communication circuitry module 312. Further, the processer 304 includes a presentation module 304a, a categorization module 304b, a facilitation module 304c, a compensator module 304d, a receiving module 304e, an assembling engine 304f, a mapping module 304g, a decision module 304h and a database 304i. The above stated components of the processor 304 enable the working of the backend system 110 for performing the refining of the delivery of one or more advertisements in the content.

The presentation module 304a in the processor 304 displays the one or more advertisements in the content viewed by the user 102. The one or more advertisements are provided on the basis of the real time bidding process. The categorization module 304b in the processor 304 facilitates the categorization of the one or more displayed advertisements. The categorization of the one or more displayed advertisements is based on the pre-determined criterion. The pre-determined criterion includes the rating of the one or more advertisements by the user 102 and the other one or more users.

The facilitation module 30c in the processor 304 facilitates the earning of the credits by watching the one or more displayed advertisements. The credits earned are based on the categorization. The compensator module 304d in the processor 304 allows the user 102 to redeem the earned credits for skipping the one or more advertisements. The quantity of credits redeemed by the user 102 is based on the comparison of the first pre-determined amount decided on the real time basis utilizing the bidding criterion with the second pre-determined amount decided by the corresponding user 102 and the other one or more users for skipping the one or more advertisements.

The receiving module 304e in the processor 304 receives the first input based on the first pre-defined criterion. The first pre-defined criterion is based on the interaction of the user 102 and the other one or more users with the one or more advertisements. The assembling engine 304f in the processor 304 collects the second input based on the second pre-defined criterion. The second pre-defined criterion is based on the skipping of the repetitive advertisement from the one or more advertisement. The mapping module 304g in the processor 304 maps the one or more attributes of the one or more displayed advertisements with the one or more attributes of each of the one or more advertisements based on the first pre-defined criterion and the one or more attributes of each of the one or more advertisements based on the second pre-defined criterion.

The decision module 304h in the processor 304 enables the decision of refining the delivery of the one or more advertisements based on the first received input and the second collected input. Further, the decision module 304h decides to skip the advertisement from the one or more advertisements. Moreover, the decision module 304h decides to play the advertisement. The database 304i in the processor 304 stores the information of the one or more users, the earned credits by each of the one or more users, the one or more attributes of each of the one or more displayed advertisements based on the first pre-defined criterion and the one or more attributes of each of the one or more displayed advertisements based on the second pre-defined criterion.

It may be noted that in FIG. 3, various modules of the backend system 110 are shown that illustrates the working of the backend system 110; however those skilled in the art would appreciate that the backend system 110 may have more number of modules that could illustrate overall functioning of the backend system 110.

Going further, the communication device 302 includes any suitable type of portable electronic device. Examples of the communication device 302 include but may not be limited to a personal e-mail device (e.g., a Blackberry™ made available by Research in Motion of Waterloo, Ontario), a personal data assistant (“PDA”), a cellular telephone, a Smartphone, the laptop computer, and the tablet computer. In another embodiment of the present disclosure, the communication device 302 can be a desktop computer.

From the perspective of this disclosure, the control circuitry module 306 includes any processing circuitry or processor operative to control the operations and performance of the communication device 302. For example, the control circuitry module 306 may be used to run operating system applications, firmware applications, media playback applications, media editing applications, or any other application.

In an embodiment, the control circuitry module 306 drives a display and process inputs received from the user interface.

From the perspective of this disclosure, the storage module 308 includes one or more storage mediums including a hard-drive, solid state drive, flash memory, permanent memory such as ROM, any other suitable type of storage component, or any combination thereof. The storage module 308 may store, for example, media data (e.g., music and video files), application data (e.g., for implementing functions on the communication device 302).

From the perspective of this disclosure, the I/O circuitry module 310 may be operative to convert (and encode/decode, if necessary) analog signals and other signals into digital data. In an embodiment, the I/O circuitry module 310 may also convert the digital data into any other type of signal and vice-versa. For example, the I/O circuitry module 310 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 306, the storage module 308 or any other component of the communication device 302.

It may be noted that the I/O circuitry module 310 is illustrated in FIG. 3 as a single component of the communication device 302; however those skilled in the art would appreciate that several instances of the I/O circuitry module 310 may be included in the communication device 302.

The communication device 302 may include any suitable interface or component for allowing the user 102 to provide inputs to the I/O circuitry module 310. The communication device 302 may include any suitable input mechanism. Examples of the input mechanism include but may not be limited to a button, keypad, dial, a click wheel, and a touch screen. In an embodiment, the communication device 302 may include a capacitive sensing mechanism, or a multi-touch capacitive sensing mechanism.

In an embodiment, the communication device 302 may include specialized output circuitry associated with output devices such as, for example, one or more audio outputs. The audio output may include one or more speakers built into the communication device 302, or an audio component that may be remotely coupled to the communication device 302.

The one or more speakers can be mono speakers, stereo speakers, or a combination of both. The audio component can be a headset, headphones or ear buds that may be coupled to the communication device 302 with a wire or wirelessly.

In an embodiment, the I/O circuitry module 310 may include display circuitry for providing a display visible to the user 102. For example, the display circuitry may include a screen (e.g., an LCD screen) that is incorporated in the communication device 302.

The display circuitry may include a movable display or a projecting system for providing a display of content on a surface remote from the communication device 302 (e.g., a video projector). In an embodiment, the display circuitry may include a coder/decoder to convert digital media data into the analog signals. For example, the display circuitry may include video Codecs, audio Codecs, or any other suitable type of Codec.

The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 306. Alternatively, the display circuitry may be operative to provide instructions to a remote display.

In addition, the communication device 302 includes the communication circuitry module 312. The communication circuitry module 312 may include any suitable communication circuitry operative to connect to a communication network and to transmit communications (e.g., voice or data) from the communication device 302 to other devices within the communications network. The communication circuitry module 312 may be operative to interface with the communication network using any suitable communication protocol. Examples of the communication protocol include but may not be limited to Wi-Fi, Bluetooth®, radio frequency systems, infrared, LTE, GSM, GSM plus EDGE, CDMA, and quadb and.

In an embodiment, the communication circuitry module 312 may be operative to create a communications network using any suitable communications protocol. For example, the communication circuitry module 312 may create a short-range communication network using a short-range communications protocol to connect to other devices. For example, the communication circuitry module 312 may be operative to create a local communication network using the Bluetooth,® protocol to couple the communication device 302 with a Bluetooth, RTM headset.

It may be noted that the computing device is shown to have only one communication operation; however, those skilled in the art would appreciate that the communication device 302 may include one more instances of the communication circuitry module 312 for simultaneously performing several communication operations using different communication networks. For example, the communication device 302 may include a first instance of the communication circuitry module 312 for communicating over a cellular network, and a second instance of the communication circuitry module 312 for communicating over Wi-Fi or using Bluetooth®.

In an embodiment of the present disclosure, the same instance of the communication circuitry module 312 may be operative to provide for communications over several communication networks. In an embodiment, the communication device 302 may be coupled to a host device for data transfers, syncing the communication device 302, software or firmware updates, providing performance information to a remote source (e.g., providing riding characteristics to a remote server) or performing any other suitable operation that may require the communication device 302 to be coupled to the host device. Several computing devices may be coupled to a single host device using the host device as a server. Alternatively or additionally, the communication device 302 may be coupled to the several host devices (e.g., for each of the plurality of the host devices to serve as a backup for data stored in the communication device 302).

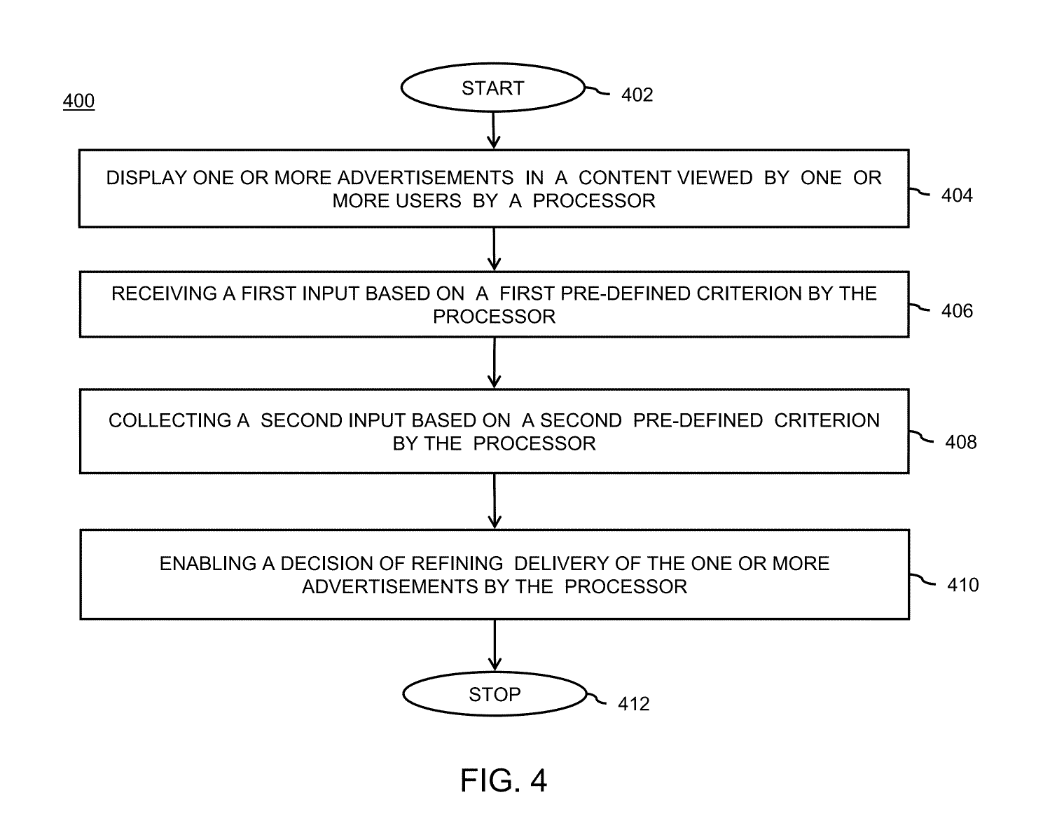

FIG. 4 illustrates a flowchart 400 for enabling refining the delivery of the one or more advertisements, in accordance with various embodiments of the present disclosure. It may be noted that to explain the process steps of FIG. 4, references will be made to the system elements of the FIG. 1, FIG. 2 and FIG. 3. The flow chart 400 initiates at step 402. Following step 402, at step 404, the presentation module 304a displays the one or more advertisements in the content viewed by the user 102-106. At step 406, the receiving module 304e receives the first input based on the first pre-defined criterion. At step 408, the assembling engine 304f collects the second input based on the second pre-defined criterion. At step 410, the decision module 304h enables the decision of refining the delivery of the one or more advertisements. The flowchart 400 terminates at step 412.

It may be noted that the flowchart 400 is explained to have above stated process steps; however, those skilled in the art would appreciated that the flowchart 400 may have more/less number of process steps which may enable all the above stated embodiments of the present disclosure.

What is claimed is:

1. A computer-implemented method for refining delivery of one or more advertisements in a content seen by one or more users, the method comprising:
displaying, with a processor, said one or more advertisements in said content viewed by said one or more users, said one or more advertisements being provided by at least one of one or more publishers and a backend system, wherein said one or more advertisements being provided to said one or more users based on a real time bidding process;
receiving, with said processor, a first input based on a first pre-defined criterion, wherein said first pre-defined criterion being based on a first interaction of a user of said one or more users with said one or more advertisements and a second interaction of said one or more users with said one or more advertisements;
collecting, with said processor, a second input based on a second pre-defined criterion, wherein said second pre-defined criterion being based on skipping of a repetitive advertisement from said one or more advertisements; and
enabling, with said processor, a decision of refining said delivery of said one or more advertisements, wherein said refining being based on said received first input and said collected second input.

2. The computer-implemented method as recited in claim 1, further comprising facilitating, with said processor, categorization of said one or more displayed advertisements, said categorization being based on a pre-determined criterion, said pre-determined criterion comprises rating of said one or more displayed advertisements by said one or more users.

3. The computer-implemented method as recited in claim 1, further comprising facilitating, with said processor, earning of credits by watching said one or more displayed advertisements by said one or more users, wherein said earning of credits being based on said categorization.

4. The computer-implemented method as recited in claim 1, further comprising allowing, with said processor, each of said one or more users to redeem said earned credits for skipping said one or more advertisements, wherein quantity of said credits redeemed by each of said one or more users being based on comparison of a first pre-determined amount decided on a real time basis utilizing a bidding criterion with a second pre-determined amount decided by corresponding said one or more users for skipping said one or more advertisements, and wherein said bidding criterion being based on said real-time bidding of one or more advertisement slots of said one or more publishers.

5. The computer-implemented method as recited in claim 1, wherein said credits being deducted from an account of each of said one or more users based on a bidding amount for skipping said one or more advertisements, and wherein said bidding amount being based on compensation methods.

6. The computer-implemented method as recited in claim 5, wherein said compensation methods comprises at least one of cost per click, cost per impression and cost per view.

7. The computer-implemented method as recited in claim 1, further comprising storing, with said processor, information of said one or more users, said earned credits by each of said one or more users, one or more attributes of each of said one or more displayed advertisements based on said first pre-defined criterion and one or more attributes of each of said one or more displayed advertisements based on said second pre-defined criterion.

8. A computer program product comprising a non-transitory computer readable medium storing a computer readable program, wherein said computer readable program when executed on a computer causes said computer to perform steps comprising:
displaying one or more advertisements in a content viewed by one or more users, said one or more advertisements being provided by at least one of one or more publishers and a backend system, wherein said one or more advertisements being provided to said one or more users based on a real time bidding process;
receiving a first input based on a first pre-defined criterion, wherein said first pre-defined criterion being based on a first interaction of a user of said one or more users with said one or more advertisements and a second interaction of said one or more users with said one or more advertisements;
collecting a second input based on a second pre-defined criterion, wherein said second pre-defined criterion being based on skipping of a repetitive advertisement from said one or more advertisements; and
enabling a decision of refining delivery of said one or more advertisements, wherein said refining being based on said received first input and said collected second input.

9. The computer program product as recited in claim 8, wherein said computer readable program when executed on said computer causes said computer to perform a further step of facilitating categorization of said one or more displayed advertisements, said categorization being based on a pre-determined criterion, said pre-determined criterion comprises rating of said one or more displayed advertisements by said one or more users.

10. The computer program product as recited in claim 8, wherein said computer readable program when executed on said computer causes said computer to perform a further step of facilitating earning of credits by watching said one or more displayed advertisements by said one or more users, wherein said earning of credits being based on said categorization.

11. The computer program product as recited in claim 8, wherein said computer readable program when executed on said computer causes said computer to perform a further step of allowing each of said one or more users to redeem said earned credits for skipping said one or more advertisements.

12. A system for refining delivery of one or more advertisements in a content seen by one or more users, the system comprising:
a presentation module in a processor, said presentation module being configured to display said one or more advertisements in said content viewed by said one or more users, said one or more advertisements being provided by at least one of one or more publishers and a backend system, wherein said one or more advertisements being provided to said one or more users based on a real time bidding process;
a receiving module in said processor, said receiving module being configured to receive a first input based on a first pre-defined criterion, wherein said first pre-defined criterion being based on a first interaction of a user of said one or more users with said one or more advertisements and a second interaction of said one or more users with said one or more advertisements;
an assembling engine in said processor, said assembling engine being configured to collect a second input based on a second pre-defined criterion, wherein said second pre-defined criterion being based on skipping of a repetitive advertisement from said one or more advertisements; and
a decision module in said processor, said decision module being configured to enable a decision of refining said delivery of said one or more advertisements, wherein said refining being based on said received first input and said collected second input.

13. The system as recited in claim 13, further comprising a categorization module in said processor, said categorization module being configured to facilitate categorization of said one or more displayed advertisements, said categorization being based on a pre-determined criterion, said pre-determined criterion comprises rating of said one or more displayed advertisements by said one or more users.

14. The system as recited in claim 13, further comprising a facilitation module in said processor, said facilitation module being configured to facilitate earning of credits by watching said one or more displayed advertisements by said one or more users, wherein said earning of credits being based on said categorization.

15. The system as recited in claim 13, further comprising a compensator module in said processor, said compensator module being configured to allow each of said one or more users to redeem said earned credits for skipping said one or more advertisements, wherein quantity of said credits redeemed by each of said one or more users being based on a comparison of a first pre-determined amount decided on said real time basis utilizing a bidding criterion with a second pre-determined amount decided by corresponding said one or more users for skipping said one or more advertisements, and wherein said bidding criterion being based on said real-time bidding of one or more advertisement slots of said one or more publishers.

16. The system as recited in claim 13, further comprising a mapping module in said processor, said mapping module being configured to map one or more attributes of each of said one or more displayed advertisements with one or more attributes of each of said one or more advertisements based on said first pre-defined criterion and one or more attributes of each of said one or more advertisements based on said second pre-defined criterion.

17. The system as recited in claim 13, wherein said one or more attributes of each of said one or more displayed advertisements comprises at least one of type of said one or more displayed advertisements and rating of said one or more displayed advertisements by said user of said one or more users and said one or more users.

18. The system as recited in claim 13, wherein said credits being deducted from an account of each of said one or more users based on a bidding amount for skipping said one or more advertisements, and wherein said bidding amount being based on compensation methods.

19. The system as recited in claim 18, wherein said compensation methods comprises at least one of cost per click, cost per impression and cost per view.

20. The system as recited in claim 13, further comprising a database in said processor, for storing information of said one or more users, said earned credits by each of said one or more users, said one or more attributes of each of said one or more displayed advertisements based on said first pre-defined criterion and said one or more attributes of each of said one or more displayed advertisements based on said second pre-defined criterion.
